(19) United States
(12) Patent Application Publication
(10) Pub. No.: US 2004/0049381 A1
(43) Pub. Date: Mar. 11, 2004

(54) Speech coding method and speech coder

(76) Inventor: Nobuaki Kawahara, Tokyo (JP)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/654,018

(22) Filed: Sep. 4, 2003

(30) Foreign Application Priority Data
Sep. 5, 2002 (JP) P. 2002-259595

(51) Int. Cl. G10L 19/10; G10L 19/08; G10L 19/04

(52) U.S. Cl. 704/219

(57) ABSTRACT

The conventional bit rate reducing techniques have a problem that the reproduced speech quality is lowered. The present invention provides a speech coding method, a speech decoding method, a speech coder, and a speech decoder that can reduce information allocated to algebraic codebook information while suppressing degradation of the reproduced speech quality as much as possible, thereby to improve the transmission efficiency.

A speech coding method, a speech decoding method, a speech coder, and a speech decoder, wherein candidate pulse positions within groups in a candidate position table are divided into a plurality of portions so as to provide a plurality of divided candidate position tables (even-number algebraic codebook and odd-number algebraic codebook), a switching section selects one divided candidate position table from the plurality of divided candidate position tables based on a pitch period value, and a minimum distortion pulse combination searching section searches for a combination of the pulse positions, one in each group, which minimizes distortion, according to the selected divided candidate position table.

### BACKGROUND OF THE INVENTION

1. Field of the Invention

The present invention relates to a speech coding method and a speech coder in digital speech compression that is essential to digital mobile communications and, in particular, relates to a speech coding method and a speech coder that can improve the digital speech compression efficiency to reduce transmission information while suppressing degradation of the reproduced speech quality as much as possible in coding by algebraic code excitation linear prediction (hereinafter referred to as “ACELP”), thereby to improve the transmission efficiency.

2. Description of the Related Art

Presently, the speech coding systems used in the public mobile communications in the countries all over the world mostly employ ACELP as the basic system thereof.

For example, the digital speech coding system called AMR (Adaptive Multi-Rate) established by GSM (Global System for Mobile) being the standard of the European mobile telephone digital coding is a system that changes a bit rate depending on conditions of a transmission line using ACELP as the basic system, and G.729 standardized by ITU-T (International Telecommunications Union-Telecommunications Standards Sector) is also a system that uses ACELP as the basic system and improves the tolerance to a transmission line error and the reproduced speech quality using a conjugate structure for gain quantization.

Further, EFR (Enhanced Full Rate) of the U.S. digital mobile telephones is also a digital speech coding system that uses ACELP as the basic system.

Furthermore, the third-generation digital speech coding system that has started services in Japan since 2001 is also a variable bit rate system established with reference to AMR employed in GSM and using ACELP as the basic system thereof.

As described above, the systems that have been presently employed worldwide as the standard systems of digital speech coding for the public mobile communications mostly use ACELP as their basic systems.

ACELP analyzes a speech signal per frame to extract a linear prediction filter coefficient (LPC coefficient), indexes of an adaptive codebook and a fixed codebook, and a gain, which are parameters used in a CELP model, then codes these parameters and transmits them.

Then, in a decoder, an excitation signal and parameters of a synthesis filter are reconstructed using the foregoing received parameters, a speech signal is reproduced by passing the excitation signal through a short-term synthesis filter, and the quality of the speech is improved by passing it through a post filter. The short-term synthesis filter is configured based on linear prediction (LP) filters, while a long-term synthesis filter, i.e. a pitch synthesis filter, is realized by using a so-called adaptive codebook.

ACELP is a system that uses a combination of pulses as a speech source signal for driving an LPC (Linear Predictive Coding) filter in CELP (Code Excited Linear Prediction), and is a system that does not have a known noise codebook in coding and decoding as a noise excitation source beforehand like the conventional CELP, but produces a drive speech source more accurately by continuously searching for a predetermined number of pulses per predetermined speech burst during a speech burst interval.

By the use of the technique of algebraically producing the drive speech source, ACELP has made it possible to realize the high-quality speech coding with a reduced calculation amount as compared with the noise excitation source search used in the conventional CELP.

As an example, an outline of the algebraic codebook searching process of ITU-T Recommendation G.729 (hereinafter referred to as “CS-ACELP”<Conjugate Structure-Algebraic Code Excitation Linear Prediction>) will be shown hereinbelow.

CS-ACELP is configured by a frame length of 10 ms and a subframe length of Sms, and expresses a drive speech source by four pulses per subframe of Sms (40 samples) at a sampling frequency of 8 kHz.

Candidate pulse positions in CS-ACELP are shown in Table 1. In CS-ACELP, positions 0 to 39 of 40 samples per subframe are allocated to groups of pulse numbers 1 to 4 as shown in Table 1, and a search for all the combinations of all the sample points (candidate positions) among the respective groups is conducted, thereby to select a combination of the pulse positions that realizes the minimum distortion as compared with a target signal.

TABLE 1
Candidate Pulse Positions in CS-ACELP

| Pulse No. | | |
|---|---|---|
| (Group) | Polarity | Candidate Pulse Position |
| 1 | ± | 0, 5, 10, 15, 20, 25, 30, 35 |
| 2 | ± | 1, 6, 11, 16, 21, 26, 31, 36 |
| 3 | ± | 2, 7, 12, 17, 22, 27, 32, 37 |
| 4 | ± | 3, 8, 13, 18, 23, 28, 33, 38 |
| | | 4, 9, 14, 19, 24, 29, 34, 39 |

As shown in Table 1, each of pulse Nos. 1 to 3 has 8 candidate pulse positions so that an index (0˜7) of a selected position can be expressed by three bits, while pulse No. 4 has 16 candidate pulse positions so that an index (0˜15) of a selected position can be expressed by four bits. In addition thereto, one bit is further required as information representing a polarity (±) of each pulse.

Therefore, as a result of conducting the algebraic codebook search in the CS-ACELP speech coding, information (algebraic code) about an algebraic codebook representing a combination of the pulse positions that realizes the minimum distortion is given by the foregoing searched polarities and indexes of the respective pulses, thus given by 17 bits/5 ms (subframe), i.e. 34 bits/frame in terms of the frame unit.

Now, explanation will be given about examples of ACELP bit rate reducing techniques that have been conventionally carried out.

As the first bit rate reducing technique, there is considered a method of reducing the number of pulses. In Table 1, if pulse numbers (groups) are reduced from four to two in a subframe in CS-ACELP, one pulse number (group) may have, for example, 8 candidate pulse positions (each index is given by three bits), while the other pulse number (group) may have 32 candidate pulse positions (each index is given by five bits)(as appreciated, the number of candidate pulse positions per pulse number (group) should be the power of 2). In addition thereto, one bit is assigned to a polarity of each pulse so that it becomes 10 bits in total, i.e. 20 bits per frame, thus a reduced number of bits per frame becomes 34-20=14 bits.

As the conventional technique for reducing the number of pulses as described above, there is one disclosed in JP-A-H10-312198 for “Speech Coding Method” (Applicant: Nippon Telegraph and Telephone Corporation; Inventors: Shinji Hayashi etc.) published on Nov. 24, 1998.

This conventional technique is a speech coding method, wherein, upon coding a noise component vector, each of two subframes forming each frame is represented by two pulses #0 and #1, i.e. pulse #0 expressing each of selectable 16 positions by four bits, while pulse #1 expressing each of selectable 24 positions by five bits, and each pulse is given one polarity bit, so that the noise component vector is expressed by 4+5+2=11 bits per subframe, thereby to reduce the bit rate (see Patent Literature 1).

As the second bit rate reducing technique, there is considered a method of omitting candidate pulse positions. For example, there is considered a method of arranging candidate pulse positions for every other sample.

If candidate pulse positions are allocated for every other sample, 8 candidates can be reduced to 4 candidates (each index is given by two bits) and 16 candidates can be reduced to 8 candidates (each index is given by three bits) in the candidate pulse positions of CS-ACELP shown in Table 1. A reduction effect according to this method is 17−13=4 bits per subframe, and thus 8 bits per frame.

According to the foregoing two kinds of general information reducing techniques, the reduction effect can be achieved to a certain level. However, according to the first bit rate reducing technique, there arises a problem that the quality is largely degraded due to reduction in number of pulses.

The first bit rate reducing technique is used in ITU-T Recommendation G.729 Annex D, wherein degradation of the reproduced speech quality caused thereby is avoided to some degree by realizing pulse dispersion through filtering.

According to the second bit rate reducing technique, there arises a problem that the quality is somewhat degraded due to an inaccurate minimum distortion search caused by continual occurrence of samples that are not searched.

The second bit rate reducing technique is used in several kinds of standardized low-bit-rate speech coding (e.g. ITU-T Recommendation G.723.1 ACELP, and AMR-NB low-bit-rate codec mode), wherein it is often employed as it is, judging that it is within the tolerance of degradation in quality following the bit rate reduction.

Further, as another conventional technique for improving the speech quality by reducing the number of bits, there is one disclosed in JP-A-H11-237899 for “Speech Source Signal Coding Device and Method, and Speech Source Signal Decoding Device and Method” (Applicant: Matsushita Electric Industrial Co., Ltd.; Inventors: Hiroyuki Ebara etc.) published on Aug. 31, 1999.

This conventional technique is a speech source signal coding device and method, and a speech source signal decoding device and method, wherein a plurality of kinds of algebraic codebooks are provided, which are switched depending on a position of the pitch peak (see Patent Literature 2).

As Patent Literature 1, there is JP-A-H10-312198 (page 5, FIG. 6).

As Patent Literature 2, there is JP-A-H11-237899 (pages 20 to 24, FIGS. 22 to 26).

However, there has been a problem that it is necessary to consider a combination of the conventional two kinds of bit rate reducing techniques for further reducing the whole bit rate, which, however, further lowers the reproduced speech quality due to a multiplier effect of the drawbacks of the respective techniques.

Further, although the degradation in quality caused by employment of the second bit rate reducing technique is often allowed, there has been a problem that the degradation is remarkably observed when a pitch period value of an input speech is small (e.g. in case of voice of a woman or child).

### SUMMARY OF THE INVENTION

It is an object of the present invention to provide a speech coding method, a speech decoding method, a speech coder, and a speech decoder that can reduce information allocated to algebraic codebook information in ACELP while suppressing degradation of the reproduced speech quality as much as possible, thereby to improve the transmission efficiency.

For solving the foregoing conventional problems, the present invention is a speech coding method using ACELP, which comprises, in an algebraic codebook search expressing a speech source signal of an input speech signal by a combination of pulses and, according to a candidate position table in which candidate pulse positions are divided into groups so as to be determined per group beforehand, searching for a combination of the pulse positions, one in each group, which minimizes distortion, dividing the candidate pulse positions within the groups in the candidate position table into a plurality of portions so as to provide a plurality of divided candidate position tables; and selecting one divided candidate position table from the plurality of divided candidate position tables based on a pitch period value and, according to the selected divided candidate position table, searching for a combination of the pulse positions, one in each group, which minimizes the distortion. Therefore, it is possible, with reduction of a load of the algebraic codebook searching process and with the simple processing, to suppress degradation of the reproduced speech quality as much as possible while reducing information allocated to the algebraic codebook information.

In the foregoing speech coding method, the present invention divides the candidate pulse positions within the groups in the candidate position table into odd-number positions and even-number positions so as to provide an odd-number candidate position table having the odd-number positions as candidates and an even-number candidate position table having the even-number positions as candidates, and selects one of the odd-number candidate position table and the even-number candidate position table based on a value of integral part of the pitch period value. Therefore, it is possible, with the simple processing, to suppress degradation of the reproduced speech quality as much as possible while reducing information allocated to the algebraic codebook information.

Further, the present invention is a speech decoding method of decoding speech coded data coded by the speech coding method of the present invention, which comprises, in algebraic codebook vector production for producing a speech source signal from the coded data expressed by a combination of pulses, retaining a plurality of divided candidate position tables like those used in the coding; and selecting one divided candidate position table from the plurality of divided candidate position tables based on a decoded pitch period value and, according to the selected divided candidate position table, producing an algebraic codebook vector having pulses of pulse positions corresponding to the coded data. Therefore, it is possible, with the simple processing, to produce a reproduced speech with quality degradation suppressed as much as possible, even from the algebraic codebook information with reduced amount of information.

The present invention is a speech decoding method of decoding speech coded data coded by the speech coding method of the present invention, which comprises, in algebraic codebook vector production for producing a speech source signal from the coded data expressed by a combination of pulses, retaining an odd-number candidate position table and an even-number candidate position table like those used in the coding; and selecting one of the odd-number candidate position table and the even-number candidate position table based on a value of integral part of a decoded pitch period value and, according to the selected candidate position table, producing an algebraic codebook vector having pulses of pulse positions corresponding to the coded data. Therefore, it is possible, with the simple processing, to produce a reproduced speech with quality degradation suppressed as much as possible, even from the algebraic codebook information with reduced amount of information.

Further, the present invention is a speech coder using ACELP, which comprises algebraic codebook searching means for expressing a speech source signal of an input speech signal by a combination of pulses and, according to a candidate position table in which candidate pulse positions are divided into groups so as to be determined per group beforehand, searching for a combination of the pulse positions, one in each group, which minimizes distortion, wherein the algebraic codebook searching means comprises a plurality of divided candidate position tables obtained by dividing the candidate pulse positions within the groups in the candidate position table into a plurality of portions; selecting means for selecting one divided candidate position table from the plurality of divided candidate position tables based on a pitch period value; and searching means for, according to the divided candidate position table selected by the selecting means, searching for a combination of the pulse positions, one in each group, which minimizes the distortion. Therefore, it is possible, with reduction of a load of the algebraic codebook searching process and with the simple processing, to suppress degradation of the reproduced speech quality as much as possible while reducing information allocated to the algebraic codebook information.

In the foregoing speech coder, the present invention is configured that the plurality of divided candidate position tables comprise an odd-number candidate position table having as candidates odd-number positions among the candidate pulse positions of the candidate position table, and an even-number candidate position table having as candidates even-number positions thereamong, and the selecting means selects one of the odd-number candidate position table and the even-number candidate position table based on a value of integral part of the pitch period value. Therefore, it is possible, with the simple processing, to suppress degradation of the reproduced speech quality as much as possible while reducing information allocated to the algebraic codebook information.

Further, the present invention is a speech decoder for decoding speech coded data coded by the speech coder of the present invention, which comprises algebraic codebook vector producing means for producing a speech source signal from the coded data expressed by a combination of pulses, wherein the algebraic codebook vector producing means comprises a plurality of divided candidate position tables like those used in the coding; selecting means for selecting one divided candidate position table from the plurality of divided candidate position tables based on a decoded pitch period value; and vector producing means for, according to the divided candidate position table selected by the selecting means, producing an algebraic codebook vector having pulses of pulse positions corresponding to the coded data. Therefore, it is possible, with the simple processing, to produce a reproduced speech with quality degradation suppressed as much as possible, even from the algebraic codebook information with reduced amount of information.

The present invention is a speech decoder for decoding speech coded data coded by the speech coder of the present invention, which comprises algebraic codebook vector producing means for producing a speech source signal from the coded data expressed by a combination of pulses, wherein the algebraic codebook vector producing means comprises an odd-number candidate position table and an even-number candidate position table like those used in the coding; selecting means for selecting one of the odd-number candidate position table and the even-number candidate position table based on a value of integral part of a decoded pitch period value; and vector producing means for, according to the candidate position table selected by the selecting means, producing an algebraic codebook vector having pulses of pulse positions corresponding to the coded data. Therefore, it is possible, with the simple processing, to produce a reproduced speech with quality degradation suppressed as much as possible, even from the algebraic codebook information with reduced amount of information.

### BRIEF DESCRIPTION OF THE DRAWINGS

FIG. 1 is a schematic structural block diagram of a speech coder according to the present invention.

FIG. 2 is a block diagram showing an internal structure of a fixed codebook search section in a speech coder according to an embodiment of the present invention.

FIG. 3 is an exemplary diagram showing candidate positions of respective pulses in case of the conventional CS-ACELP.

FIG. 4 are exemplary diagrams showing candidate positions of respective pulses according to the present invention, wherein FIGS. 4A1, 4F, 4G, 4H and 4I show odd-number candidates and FIGS. 4A2, 4J, 4K, 4L and 4M show even-number candidates.

FIG. 5 is an exemplary diagram showing searched pulse positions of an algebraic codebook.

FIG. 6 is a schematic structural block diagram of a speech decoder according to the present invention.

FIG. 7 is a block diagram showing an internal structure of a fixed code vector output section in the speech decoder of the present invention.

### DESCRIPTION OF REFERENCE NUMERALS

1 . . . preprocessing section, 2 . . . LPC analyzing quantizing interpolating section, 3 . . . acoustic sense weighting section, 4 . . . adaptive codebook search section, 5 . . . fixed codebook search section, 6 . . . gain calculating section, 7 . . . LPC synthesizing section, 8 . . . square error minimizing section, 9 . . . multiplexing section, 20 . . . adder, 21 . . . multiplier, 22 . . . multiplier, 23 . . . adder, 31 . . . separating section, 32 . . . adaptive code vector output section, 33 . . . fixed code vector output section, 34 . . . gain vector output section, 35 . . . multiplier, 36 . . . multiplier, 37 . . . adder, 38 . . . LPC synthesizing section, 39 . . . post filter, 51 . . . even-number algebraic codebook, 52 . . . odd-number algebraic codebook, 53 . . . switching section, 54 . . . minimum distortion pulse combination searching section, 61 . . . even-number algebraic codebook, 62 . . . odd-number algebraic codebook, 63 . . . switching section, 64 . . . fixed code vector producing section

### DESCRIPTION OF THE PREFERRED EMBODIMENT

Preferred embodiments of the present invention will be described hereinbelow with reference to the accompanying drawings.

Function realizing means, which will be described hereinbelow, may be any circuit or device as long as it is means that can realize the subject function. Part or the whole of the function may be realized by software. Further, function realizing means may be realized by a plurality of circuits, or a plurality of function realizing means may be realized by a single circuit.

A speech coding/decoding method according to the present invention, in an algebraic codebook search on the coding side, divides candidate pulse positions within groups in a candidate position table into a plurality of portions thereby to provide a plurality of divided candidate position tables, selects one divided candidate position table from the plurality of divided candidate position tables based on a pitch period value and, according to the selected divided candidate position table, searches for a combination of the pulse positions, one in each group, which minimizes distortion, and on the decoding side, retains a plurality of divided candidate position tables like those on the coding side, selects one divided candidate position table from the plurality of divided candidate position tables based on a decoded pitch period value and, according to the selected divided candidate position table, produces an algebraic codebook vector having pulses of the pulse positions corresponding to coded data. Therefore, it is possible to suppress degradation of the reproduced speech quality as much as possible while reducing information allocated to algebraic codebook information.

In a speech coder according to the present invention, algebraic codebook searching means comprises a plurality of divided candidate position tables obtained by dividing candidate pulse positions within groups in a candidate position table into a plurality of portions, selecting means for selecting one divided candidate position table from the plurality of divided candidate position tables based on a pitch period value, and searching means for, according to the divided candidate position table selected by the selecting means, searching for a combination of the pulse positions, one in each group, which minimizes the distortion. In a speech decoder according to the present invention, algebraic codebook vector producing means comprises a plurality of divided candidate position tables like those used in the coding, selecting means for selecting one divided candidate position table from the plurality of divided candidate position tables based on a decoded pitch period value, and vector producing means for, according to the divided candidate position table selected by the selecting means, producing an algebraic codebook vector having pulses of pulse positions corresponding to the coded data. Therefore, it is possible to suppress degradation of the reproduced speech quality as much as possible while reducing information allocated to algebraic codebook information.

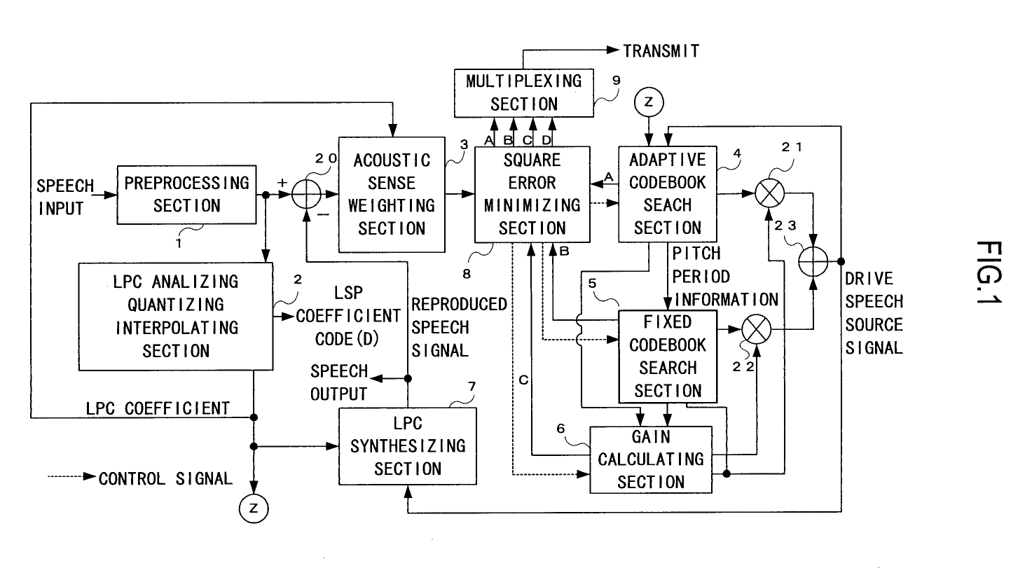

Correspondence between respective means of the present invention and respective sections of FIGS. 1, 2, 6 and 7 is such that algebraic codebook searching means corresponds to a fixed codebook search section 5, a divided candidate position table corresponds to an even-number algebraic codebook 51, an odd-number algebraic codebook 52, an even-number algebraic codebook 61 or an odd-number algebraic codebook 62, selecting means corresponds to a switching section 53 or a switching section 63, searching means corresponds to a minimum distortion pulse combination searching section 54, algebraic codebook vector producing means corresponds to a fixed code vector output section 33, and vector producing means corresponds to a fixed code vector producing section 64.

First, description will be given about a general schematic structural example of a speech coder of algebraic code excitation linear prediction (ACELP) as a basis of the present invention, using FIG. 1. FIG. 1 is a schematic structural block diagram of a speech coder according to the present invention.

As shown in FIG. 1, the speech coder according to this embodiment (the subject speech coder) comprises a preprocessing section 1, an LPC analyzing quantizing interpolating section 2, an acoustic sense weighting section 3, an adaptive codebook search section 4, a fixed codebook search section 5, a gain calculating section 6, an LPC synthesizing section 7, a square error minimizing section 8, and a multiplexing section 9. Although not shown in the figure, a timing control section, which controls operations of the respective sections on the whole, controls the overall speech coder according to the frame timing and the subframe timing.

The respective sections of the subject speech coder will be briefly described.

The preprocessing section 1 performs signal scaling and high-pass filtering.

The LPC analyzing quantizing interpolating section 2 carries out linear prediction (LP) analysis per frame to calculate an LP filter coefficient (LPC coefficient), transforms the calculated LPC coefficient into a line spectrum pair (LSP) to quantize it, outputs an LSP coefficient code (D), and further performs interpolation thereof, thereby to output an LPC coefficient inversely transformed based on a result of the quantization and interpolation.

An adder 20 derives a difference between an input speech signal that has been preprocessed and a reproduced speech signal of a previous frame, and outputs an error signal.

The acoustic sense weighting section 3 applies an acoustic sense weighting process (known technique) to the input error signal per subframe using an LPC coefficient, thereby to output an acoustic sense weighted error signal.

The adaptive codebook search section 4 searches for a pitch period component per subframe. Specifically, following a control signal from the later-described square error minimizing section 8, the adaptive codebook search section 4 goes back by a certain delay (pitch period) relative to a past drive speech source signal, extracts samples of a subframe length from that point to allot them to a current subframe, detects a pitch period that is produced based on them so as to minimize an error between the reproduced speech signal and the input speech signal, and outputs information about the detected pitch period as an adaptive code (A) to the square error minimizing section 8 and also to the fixed codebook search section 5.

Further, the adaptive codebook search section 4 extracts a waveform signal corresponding to the number of samples in a subframe from a past drive speech source signal based on the detected pitch period, and outputs it as an adaptive code vector to the gain calculating section 6 for calculating a gain, and also outputs it for producing a past drive speech source signal.

The fixed codebook search section 5 searches for a random component (also referred to as “noise component”) other than the pitch period component per subframe. Specifically, the fixed codebook search section 5 searches for a noise component relative to a target signal obtained by subtracting an adaptive code vector contribution based on the pitch period detected at the adaptive codebook search section 4 and an adaptive codebook gain calculated at the later-described gain calculating section 6, from the input speech signal.

If a search is carried out which also considers a combination of an adaptive code vector and a fixed code vector, a vector that is synthesized through a synthesis filter from drive speech source vectors produced by combining the adaptive code vector and the fixed code vector is used as a target signal, and a search for a noise component is conducted relative to the target signal.

Particularly, in ACELP, a noise component is expressed by a combination of a plurality of pulses, wherein a process is implemented that searches for the optimum combination of pulse positions, one per pulse group, from a plurality of candidate pulse positions, which are limitedly predetermined per pulse group, in a plurality of predetermined pulse groups.

Specifically, there is provided a fixed codebook (referred to also as “algebraic codebook” in ACELP, and as “candidate position table” in claims) defining candidate positions with respect to a plurality of predetermined pulse groups, and a search process is carried out relative to all the pulse position candidates in terms of all the combinations thereof, by selecting one pulse position from each group, following a control signal from the later-described square error minimizing section 8 and basically based on the content of the algebraic codebook.

The search process is a process that gives a polarity to a pulse selected in each group, outputs a pulse waveform signal as a fixed code vector, and detects a combination of pulses that minimizes a square error between the reproduced speech signal produced based on such a fixed code vector and the foregoing target signal.

Then, with respect to the detected combination of pulses that minimizes the error, an algebraic code composed of a polarity and an index of a table representing a pulse position for each pulse group is outputted to the square error minimizing section 8 as a fixed code (B).

A pulse waveform signal formed by the detected combination of pulses is handled as a fixed code vector (referred to also as “algebraic codebook vector” in ACELP), and a weighted fixed code vector that has been weighted for gain calculation is outputted to the gain calculating section 6, and the fixed code vector is also outputted for producing a past drive speech source signal.

In the fixed codebook search section 5 of the present invention, a method of dealing with the candidate positions with respect to the plurality of predetermined pulse groups, and a method of conducting the search for the combination of pulses following the control signal from the square error minimizing section 8 differ from the conventional techniques, details of which will be described later.

Following a control signal from the later-described square error minimizing section 8, the gain calculating section 6 derives an adaptive codebook gain and a fixed codebook gain that minimize a weighted mean square error between the input speech and the reproduced speech, from the adaptive code vector inputted from the adaptive codebook search section 4 and the (weighted) fixed code vector inputted from the fixed codebook search section 5, and outputs them to the square error minimizing section 8 as a gain code.

The derived adaptive codebook gain and fixed codebook gain are also outputted for producing a past drive speech source signal.

The square error minimizing section 8 is inputted with the acoustic sense weighted error signal weighted at the acoustic sense weighting section 3, and outputs the control signals to the adaptive codebook search section 4, the fixed codebook search section 5, and the gain calculating section 6 for causing them to search for the respective codes that minimize an acoustic sense weighted error, then receives an adaptive code (A) being an index of the adaptive codebook, a fixed code (B) being an index of the fixed codebook, and a gain code (C) formed by the adaptive code gain and the fixed code gain, which are search results at the respective sections 4-6 that minimize the acoustic sense weighted error, and outputs them to the multiplexing section 9 as excitation parameters.

A multiplier 21 performs multiplication between the adaptive code vector outputted from the adaptive codebook search section 4 and the adaptive code gain outputted from the gain calculating section 6.

A multiplier 22 performs multiplication between the fixed code vector outputted from the fixed codebook search section 5 and the fixed code gain outputted from the gain calculating section 6.

An adder 23 derives the sum of a result of the multiplication between the adaptive code vector and the adaptive code gain which is outputted from the multiplier 21, and a result of the multiplication between the fixed code vector and the fixed code gain which is outputted from the multiplier 22, and outputs a drive speech source signal.

The LPC synthesizing section 7 reproduces the speech signal based on the LPC coefficient outputted from the LPC analyzing quantizing interpolating section 2 and the drive speech source signal outputted from the adder 23, and outputs a reproduced speech signal on the coding side.

The multiplexing section 9 multiplexes into a bit stream the excitation signal parameters composed of the adaptive code (A), the fixed code (B), and the gain code (C) from the square error minimizing section 8, and the LSP coefficient code (D) from the LPC analyzing quantizing interpolating section 2, and transmits it as speech coded data.

Now, description will be given about the basic operation of the speech coder according to this embodiment (the subject speech coder) using FIG. 1.

In the subject speech coder, when a speech signal to be transmitted is inputted, it is subjected to the preprocessing of scaling and high-pass filtering at the preprocessing section 1, then LPC-analyzed, transformed into an LSP coefficient, quantized and interpolated at the LPC analyzing quantizing interpolating section 2 so that an LPC coefficient and an LSP coefficient code (D) are outputted, wherein the LSP coefficient code (D) is outputted to the multiplexing section 9 where it is multiplexed with the excitation signal parameters including the adaptive code (A), the fixed code (B), and the gain code (C) so as to be formed into a bit stream, thereby to be transmitted as speech coded data.

On the other hand, the speech signal after the preprocessing outputted from the preprocessing section 1 is inputted into the adder 20 that derives a difference between the speech signal after the preprocessing and a one-frame prior reproduced speech signal on the coding side and outputs an error signal. Then, the acoustic sense weighting section 3 applies acoustic sense weighting to the error signal using the LPC coefficient from the LPC analyzing quantizing interpolating section 2, so that an acoustic sense weighted error signal is inputted into the square error minimizing section 8.

First, the square error minimizing section 8 outputs to the adaptive codebook search section 4 a control signal (dotted-line arrow in the figure) commanding a search for an adaptive code of a pitch period that minimizes the acoustic sense weighted error. Then, the adaptive codebook search section 4 detects the pitch period that minimizes the error signal, and outputs information about the detected pitch period to the square error minimizing section 8 as an adaptive code (A). Further, the adaptive codebook search section 4 extracts a signal corresponding to the number of samples in a subframe from a past drive speech source signal based on the detected pitch period, and outputs it to the gain calculating section 6 as an adaptive code vector.

Then, the square error minimizing section 8 outputs to the gain calculating section 6 a control signal (dotted-line arrow in the figure) commanding calculation of a gain of an adaptive code, so that the gain calculating section 6 derives an adaptive codebook gain from the adaptive code vector outputted from the adaptive codebook search section 4, and outputs it.

Then, normally, the square error minimizing section 8 outputs to the fixed codebook search section 5 a control signal (dotted-line arrow in the figure) commanding a search for pulse positions that minimize the acoustic weighted error, relative to a target signal obtained by subtracting an adaptive code vector contribution from the input speech signal, so that the fixed codebook search section 5 searches for a combination of pulses that minimizes the error signal. As a result, an algebraic code representing polarities and pulse positions (indexes) about the respective pulses of the combination that minimizes the error signal is outputted to the square error minimizing section 8 as a fixed code (B). Further, the fixed codebook search section 5 outputs a pulse waveform signal having the pulses of the combination that minimizes the error signal, as a fixed code vector (algebraic codebook vector).

Then, the square error minimizing section 8 outputs to the gain calculating section 6 a control signal (dotted-line arrow in the figure) commanding calculation of a gain of a fixed code. In response thereto, the gain calculating section 6 derives a fixed codebook gain from the weighted fixed code vector inputted from the fixed codebook search section 5, and outputs it and the already derived adaptive codebook gain to the square error minimizing section 8 as a gain code.

As a result of the foregoing operation, the square error minimizing section 8 determines, per subframe, excitation signal parameters composed of the adaptive code (A), the fixed code (B), and the gain code (C) that minimize the acoustic sense weighted error, and outputs them to the multiplexing section 9. Then, the multiplexing section 9 multiplexes the LPC coefficient outputted from the LPC analyzing quantizing interpolating section 2 per frame, and the excitation signal parameters outputted from the square error minimizing section 8 per subframe, so as to form them into a bit stream, and transmits it.

Then, when the excitation signal parameters in the subframe are determined, the adaptive code vector from the adaptive codebook search section 4 and the adaptive codebook gain from the gain calculating section 6 are multiplied therebetween at the multiplier 21, the fixed code vector from the fixed codebook search section 5 and the fixed codebook gain from the gain calculating section 6 are multiplied therebetween at the multiplier 22, and a result of the multiplication at the multiplier 21 and a result of the multiplication at the multiplier 22 are added together at the adder 23 so as to be outputted as a one-subframe prior drive speech source signal.

The drive speech source signal is inputted into the adaptive codebook search section 4 where it is used for detecting a pitch period of the next subframe, and also inputted into the LPC synthesizing section 7 where the speech signal is reproduced using the LPC coefficient outputted from the LPC analyzing quantizing interpolating section 2 and the drive speech source signal, and outputted to the adder 20 as a reproduced speech signal on the coding side. At the adder 20, the reproduced speech signal is subjected to subtraction relative to the input speech signal.

The foregoing structure and operation described using FIG. 1 are the general structure and operation of the ACELP speech coder as a basis of the present invention. A characterizing part of the present invention differs from the conventional techniques in a method of acquiring the fixed code vector.

Specifically, the conventional ACELP speech coding method performs the search processing relative to candidate pulse positions as shown in Table 1 per subframe so as to detect polarities of pulses and pulse positions that minimize a square error between a target signal and a reproduced speech signal produced based on an outputted fixed code vector, and outputs a pulse waveform signal composed of a plurality of pulses corresponding to the detected pulse polarities and pulse positions, as a fixed code vector. On the other hand, in the present invention, there are provided in advance a plurality of divided candidate position tables that are obtained by dividing candidate pulse positions in pulse groups, and search processing is implemented relative to the divided candidate position table selected from the plurality of divided candidate position tables.

As a result, following the division of the candidate pulse positions into a plurality of portions, the number of information bits of an index representing a searched pulse position is reduced.

Specifically, in the structure of the speech coder of FIG. 1, a search processing control of the fixed codebook search section 5 differs from the conventional techniques in that the fixed codebook search section 5 of the present invention is provided beforehand with a plurality of divided candidate position tables that are obtained by dividing candidate pulse positions in pulse groups, and search processing is implemented relative to the divided candidate position table selected from the plurality of divided candidate position tables.

Inasmuch as the candidates in each pulse group are reduced, information bits of an index representing a searched pulse position is reduced so that information (algebraic code) representing polarities and positions of pulses that minimize the square error, which is outputted from the fixed codebook search section 5 to the square error minimizing section 8, i.e. the number of bits of the fixed code (B), is reduced, and thus it is possible to reduce the number of information bits that are transmitted from the square error minimizing section 8 via the multiplexing section 9.

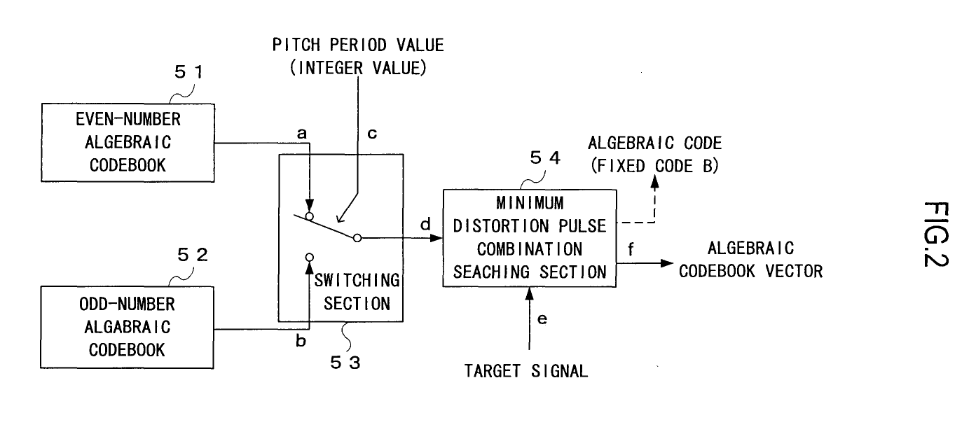

Here, description will be given about an example of an internal structure of the fixed codebook search section 5 in the speech coder of the present invention, using FIG. 2. FIG. 2 is a block diagram showing an internal structure of the fixed codebook search section 5 in the speech coder of the embodiment of the present invention. FIG. 2 shows a structural example wherein the candidate pulse positions are divided into two.

As shown in FIG. 2, the inside of the fixed codebook search section 5 in the speech coder of the present invention comprises an even-number algebraic codebook 51, an odd-number algebraic codebook 52, a switching section 53, and a minimum distortion pulse combination searching section 54.

Here, the even-number algebraic codebook 51 and the odd-number algebraic codebook 52 correspond to divided candidate position tables in claims and, in particular, the even-number algebraic codebook 51 corresponds to an even-number candidate position table, while the odd-number algebraic codebook 52 corresponds to an odd-number candidate position table.

The respective sections of the inside of the fixed codebook search section 5 will be described.

With respect to the candidate pulse positions in CS-ACELP shown in Table 1, the even-number algebraic codebook 51 retains only even-number pulse positions as candidates on a table, and outputs information about the retained pulse positions as even-number candidate pulse positions a according to a request.

TABLE 2
Example of Candidate Pulse Positions
in Even-Number Arrangement

| Pulse No. | |
|---|---|
| (Group) | Candidate Pulse Position |
| 1 | 0, 10, 20, 30 |
| 2 | 6, 16, 26, 36 |
| 3 | 2, 12, 22, 32 |
| 4 | 8, 18, 28, 38 |
| | 4, 14, 24, 34 |

With respect to the candidate pulse positions in CS-ACELP shown in Table 1, the odd-number algebraic codebook 52 retains only odd-number pulse positions as candidates in a table, and outputs information about the retained pulse positions as odd-number candidate pulse positions b according to a request.

TABLE 3
Example of Candidate Pulse Positions
in Odd-Number Arrangement

| Pulse No. | |
|---|---|
| (Group) | Candidate Pulse Position |
| 1 | 5, 15, 25, 35 |
| 2 | 1, 11, 21, 31 |
| 3 | 7, 17, 27, 37 |
| 4 | 3, 13, 23, 33 |
| | 9, 19, 29, 39 |

The switching section 53 is inputted with pitch period information (pitch period value) c outputted from the adaptive codebook search section 4, and switches between the even-number candidate pulse positions a from the even-number algebraic codebook 51 and the odd-number candidate pulse positions b from the odd-number algebraic codebook 52 depending on a value of integral part of the inputted pitch period value, thereby to output them as candidate pulse position information d.

Specifically, the switching section 53 derives the integral part of the inputted pitch period value c to judge whether the integral part is an odd number or an even number. If it is the even number, the switching section 53 switches upward in the figure so that the even-number candidate pulse positions a composed of only the even numbers and obtained from the even-number algebraic codebook 51 are inputted into the minimum distortion pulse combination searching section 54 as the candidate pulse position information d. On the other hand, if it is the odd number, the switching section 53 switches downward in the figure so that the odd-number candidate pulse positions b composed of only the odd numbers and obtained from the odd-number algebraic codebook 52 are inputted into the minimum distortion pulse combination searching section 54 as the candidate pulse position information d.

It may also be configured that a value of integral part of the pitch period value c is derived at the adaptive codebook search section 4, and inputted into the switching section 53.

The minimum distortion pulse combination searching section 54 is inputted with a target signal e for use in a search for the optimum pulse positions and polarities, searches all the possible pulse combinations of the candidate pulse positions based on the candidate pulse position information d inputted from the switching section 53 so as to detect a pulse combination having the minimum distortion as compared with the target signal, and outputs an algebraic code formed by polarities of and indexes representing positions of the detected pulses, and further outputs a pulse waveform signal formed by the combination of the detected pulses, as a fixed code vector (algebraic codebook vector).

Description will be given about an operation of the fixed codebook search section 5 of the present invention, using FIG. 2.

In the fixed codebook search section 5 of the present invention, the pitch period information (pitch period value) c outputted from the adaptive codebook search section 4 is inputted into the switching section 53, and a value of integral part of the pitch period information (pitch period value) is derived and, if the integral part is an even number, the even-number candidate pulse positions a from the even-number algebraic codebook 51 are inputted into the minimum distortion pulse combination searching section 54 as the candidate pulse position information d, while, if the integral part is an odd number, the odd-number candidate pulse positions b from the odd-number algebraic codebook 52 are inputted into the minimum distortion pulse combination searching section 54 as the candidate pulse position information d.

Then, the minimum distortion pulse combination searching section 54 searches all the possible pulse combinations of the candidate pulse positions based on the candidate pulse position information d from the switching section 53 so as to detect a pulse combination having the minimum distortion as compared with the inputted target signal, and outputs polarities of and indexes representing positions of the detected pulses as an algebraic code, and further outputs a pulse waveform signal composed of the combination of the detected pulses, as a fixed code vector (algebraic codebook vector).

In the foregoing description, when the integral part of the pitch period information is an even number, the candidate pulse positions of even-number arrangement retained in the even-number algebraic codebook 51 are selected and searched, while, when the integral part is an odd number, the candidate pulse positions of odd-number arrangement retained in the odd-number algebraic codebook 52 are selected and searched. However, inverse selection may also be allowed.

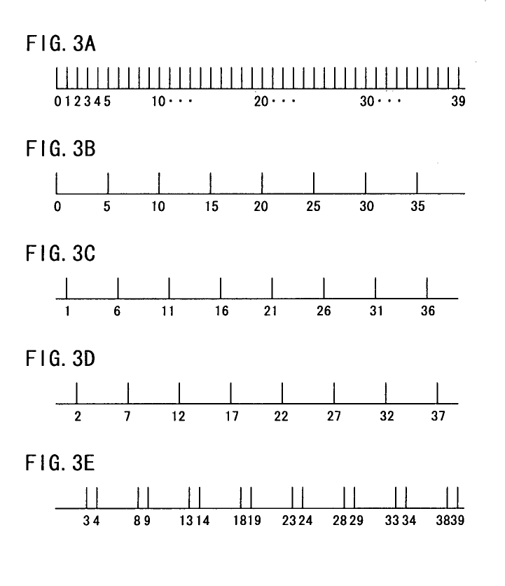

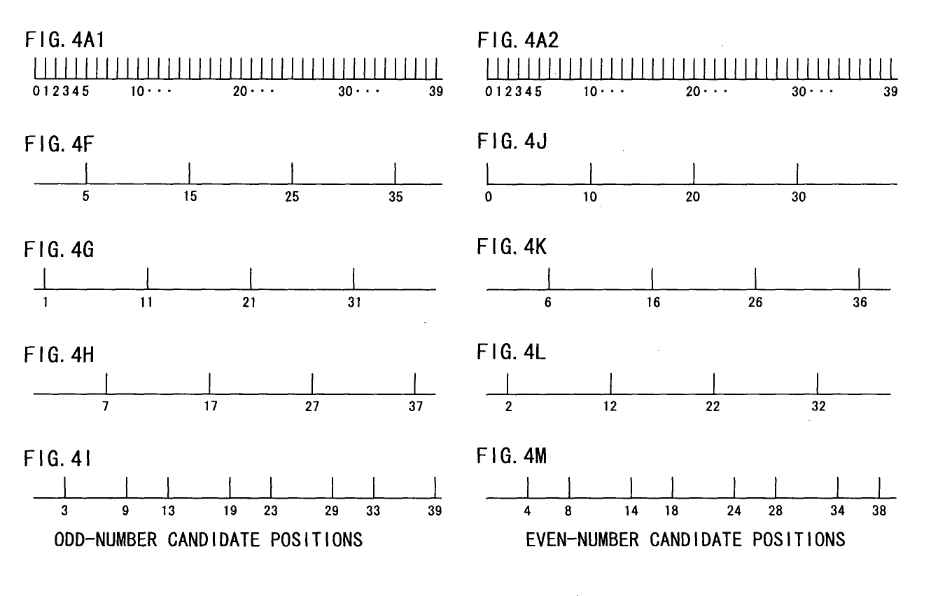

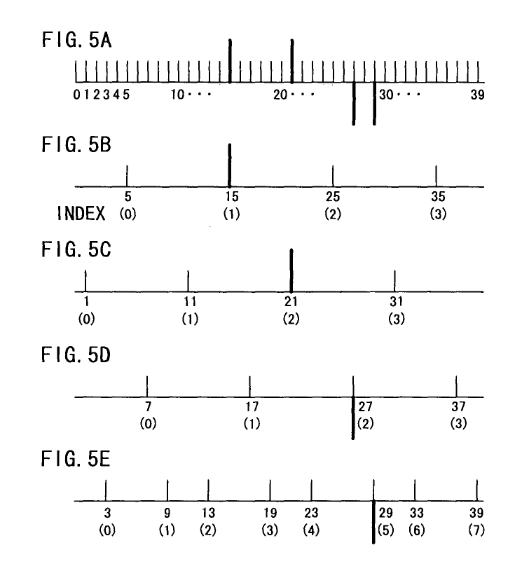

According to the speech coding method and the speech coder of the present invention, the data amount of the algebraic code can be reduced as compared with the conventional CS-ACELP, which will be explained hereinbelow using specific examples shown in FIGS. 3 to 5. FIG. 3 is an exemplary diagram showing candidate positions of respective pulses in case of the conventional CS-ACELP. FIGS. 4A and 4B are exemplary diagrams showing candidate positions of respective pulses according to the present invention, wherein FIGS. 4A1, 4F, 4H and 4I show odd-number candidates and FIGS. 4A2, 4J, 4K, 4L and 4M show even-number candidates. FIG. 5 is an exemplary diagram showing searched pulse positions of an algebraic codebook.

An algebraic codebook of CS-ACELP is composed of four channels, and one pulse having an amplitude of +1 or −1 is outputted from each channel. A position of a pulse outputted from each channel is limited so that the pulse is raised only in a position within a predetermined range. In CS-ACELP, coding of an excitation signal is implemented per subframe of 40 samples (5 ms). FIG. 3A shows respective sample points in one subframe.

In an algebraic codebook of the conventional CS-ACELP, as shown in Table 1, these 40 sample points are divided into four groups (pulse Nos. 1 to 4) shown in FIG. 3B to FIG. 3E.

Specifically, when a number of the head sample point is set to 0 and subsequent sample points are given 1, 2, 3, . . . , 39 in order, FIG. 3B shows a group composed of the sample points having numbers each of which can be divided by 5 without a remainder, i.e. the sample points 0, 5, 10, . . . , 35.

Similarly, FIG. 3C shows a group composed of the sample points having numbers each of which leaves 1 when divided by 5, i.e. the sample points 1, 6, 11, . . . , 36. Similarly, FIG. 3D shows a group composed of the sample points having numbers each of which leaves 2 when divided by 5, i.e. the sample points 2, 7, 12, . . . , 37. Similarly, FIG. 3E shows a group composed of the sample points having numbers each of which leaves 3 or 4 when divided by 5, i.e. the sample points 3, 8, 13, . . . , 38, and 4, 9, 14, . . . , 39.

On the other hand, in the speech coder of the present invention, the candidate pulse positions of the four groups (pulse Nos. 1 to 4) shown in FIG. 3 are divided into those of even-number arrangement (Table 2) and those of odd-number arrangement (Table 3), wherein the pulse positions shown in FIG. 4F to FIG. 41 are searched in the odd-number arrangement, while the pulse positions shown in FIG. 4J to FIG. 4M are searched in the even-number arrangement. In the structure of FIG. 2, information about the pulse positions shown in FIG. 4F to FIG. 4I is retained in the odd-number algebraic codebook 52, while information about the pulse positions shown in FIG. 4J to FIG. 4M is retained in the even-number algebraic codebook 51.

As a specific example, assuming that a pitch period value from the adaptive codebook search section 4 is an odd number, and thus the odd-number algebraic codebook 52 is selected, that a search is made with respect to the pulse positions shown in FIG. 4F to FIG. 41 by selecting one from the sample points included in each pulse group to raise a pulse with an amplitude of +1 or −1, and that the pulse positions in the respective pulse groups shown by thick long lines in FIG. 5B to FIG. 5E are pulse positions that minimize distortion in all the pulse combinations, a pulse waveform signal shown in FIG. 5A, which combines the subject four pulses, becomes a fixed code vector (algebraic codebook vector) outputted from the minimum distortion pulse combination searching section 54.

In this event, an algebraic code representing polarities and positions of the pulses that minimize the distortion includes a polarity of plus and an index of 1 for the group 1, a polarity of plus and an index of 2 for the group 2, a polarity of minus and an index of 2 for the group 3, and a polarity of minus and an index of 5 for the group 4, and is outputted to the square error minimizing section 8, so that a subframe can be expressed by an algebraic code of 13 bits.

Incidentally, if the pulse detection result shown in FIG. 5 is expressed by the conventional candidate pulse structure shown in Table 1, an algebraic code includes a polarity of plus and an index of 3 for the pulse 1, a polarity of plus and an index of 4 for the pulse 2, a polarity of minus and an index of 5 for the pulse 3, and a polarity of minus and an index of 13 for the pulse 4, and is outputted to the square error minimizing section 8. Therefore, as described with respect to the conventional technique, a subframe is expressed by an algebraic code of 17 bits. Accordingly, as compared with the conventional ACELP, reduction of 17−13=4 bits is achieved per subframe.

In the foregoing fixed codebook search section 5, the pulse positions of even-number arrangement or the pulse positions of odd-number arrangement are selected depending on whether the integer value of the pitch period information detected at the adaptive codebook search section 4 is an even number or an odd number, thereby to perform a search for the pulse combination, and indexes of the arrangement (algebraic codebook) corresponding to the pulse positions of the search result become an algebraic code. Therefore, inasmuch as the number of bits of the algebraic code per subframe can be reduced, it is possible to reduce the bit rate of the transmitted speech coded data, and further reduce a load of the fixed codebook search in the fixed codebook search section 5.

As explained with respect to the conventional second bit rate reducing technique, according to the method of simply omitting the candidate pulse positions, the speech quality is degraded because of continual occurrence of the pulse positions that are not searched. On the other hand, in the speech coding method of the present invention, inasmuch as the divided candidate positions to be selected are switched, there are no such pulse positions that are not searched continually so that degradation of the speech quality can be suppressed.

As described above, according to the speech coding method and the speech coder of the present invention, the pulse positions of even-number arrangement or the pulse positions of odd-number arrangement are selected depending on whether the integer value of the pitch period information is an even number or an odd number, thereby to conduct a search for the pulse combination for each of subframes forming a frame, and indexes and polarities based on the selected arrangement and corresponding to the search result (pulse position information) become an algebraic code, wherein information as to which of the even-number and odd-number arrangements was used for searching for the indexes is not included in the speech coded data.

Following it, description will be given about a speech decoding method and a speech decoder that perform decoding in response to receipt of the speech coded data which does not include the information as to which of the arrangements was used for searching for the indexes.

The speech decoding method of the present invention basically acquires the adaptive code vector based on the adaptive code of the coded excitation signal parameters, and the fixed code vector based on the fixed code thereof, produces the drive speech source signal from the adaptive code vector, the fixed code vector, and the adaptive code gain and the fixed code gain based on the coded excitation signal parameters, and reproduces the speech signal using the drive speech source signal and the linear prediction filter coefficient. As a feature of the present invention, a method of producing the fixed code (algebraic codebook) vector based on the fixed code (algebraic code) of the excitation signal parameters retains a plurality of algebraic codebooks like those on the speech coding side, selects the algebraic codebook based on the decoded pitch period information, and obtains the fixed code (algebraic codebook) vector according to the selected algebraic codebook.

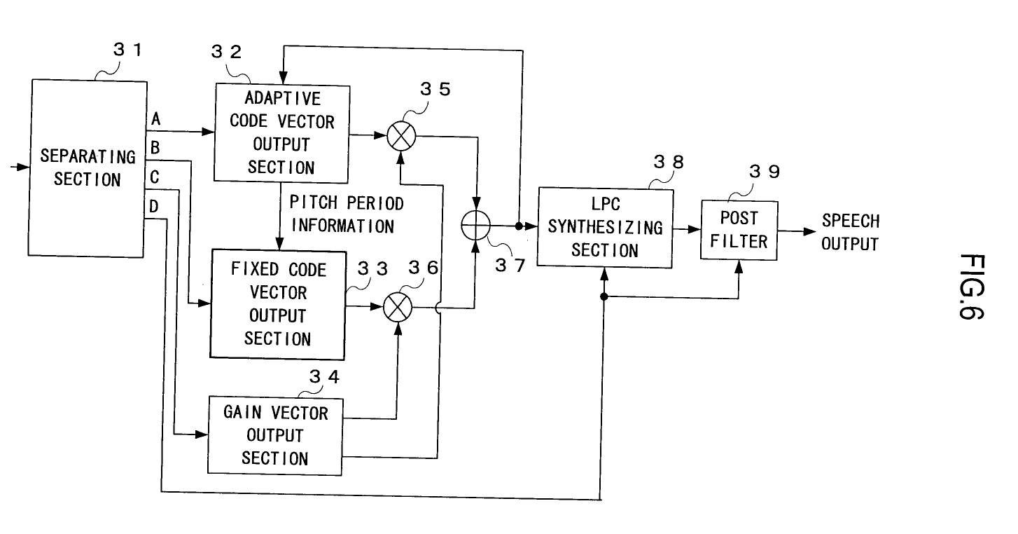

Now, description will be given about a schematic structural example of a speech decoder corresponding to the foregoing ACELP speech coding according to the present invention, using FIG. 6. FIG. 6 is a schematic structural block diagram of the speech decoder according to the present invention.

As shown in FIG. 6, the speech decoder of the present invention comprises a separating section 31, an adaptive code vector output section 32, a fixed code vector output section 33, a gain vector output section 34, a multiplier 35, a multiplier 36, an adder 37, an LPC synthesizing section 38, and a post filter 39.

Although not shown in the figure, a timing control section, which controls operations of the respective sections on the whole, controls the overall speech decoder according to the frame timing and the subframe timing.

The respective sections of the speech decoder of the present invention will be briefly described.

The separating section 31 separates the received speech coded data into an adaptive code (A), a fixed code (B), a gain code (C), and an LSP coefficient code (D), and outputs them.

The adaptive code vector output section 32 decodes the adaptive code (A) to derive a pitch period and outputs it, and extracts a waveform signal corresponding to the number of samples in a subframe from a past drive speech source signal based on the pitch period, thereby to output it as an adaptive code vector.

The fixed code vector output section 33 has a fixed codebook (referred to also as “algebraic codebook” in ACELP) storing in advance candidate pulse positions with respect to a plurality of pulse groups like on the speech coding side, and outputs as a fixed code vector a pulse waveform signal having pulses that are arranged using the fixed codebook based on a combination of pulse positions and polarities (±) shown in the fixed code (B).

It is to be noted that the fixed code vector output section 33 of the present invention retains a plurality of fixed codebooks like those on the speech coding side, selects one of the fixed codebooks according to pitch period information from the adaptive code vector output section 32, produces the fixed code vector using the selected fixed codebook, and outputs it, which differs from the conventional one. Details will be described later.

The gain vector output section 34 outputs an adaptive codebook gain and a fixed codebook gain based on the gain code (C).

The multiplier 35 multiplies the adaptive code vector from the adaptive code vector output section 32 by the adaptive codebook gain from the gain vector output section 34.

The multiplier 36 multiplies the fixed code vector from the fixed code vector output section 33 by the fixed codebook gain from the gain vector output section 34.

The adder 37 adds together a result of the multiplication by the multiplier 35 and a result of the multiplication by the multiplier 36 so as to output a drive speech source signal of the later-described LPC synthesizing section 38.

The LPC synthesizing section 38 reproduces the speech signal based on an LPC coefficient derived from the LSP coefficient code (D), and the drive speech source signal outputted from the adder 37, thereby to output a reproduced speech signal.

The post filter 39 performs processing such as spectral reshaping relative to the reproduced speech signal outputted from the LPC synthesizing section 38, using the LPC coefficient derived from the LSP coefficient code (D), thereby to output a reproduced speech of which the speech quality has been improved.

Now, description will be given about the basic operation of the speech decoder according to this embodiment, using FIG. 6.

In the speech decoder of the present invention, the received speech coded data is separated into the adaptive code (A), the fixed code (B), the gain code (C), and the LSP coefficient code (D) at the separating section 31.

The adaptive code (A) is decoded at the adaptive code vector output section 32. The adaptive code vector output section 32 then derives a pitch period and outputs it, and further outputs an adaptive code vector obtained by extracting a waveform signal corresponding to the number of samples in a subframe from a stored past drive speech source signal based on the pitch period.

On the other hand, the fixed code (B) is inputted into the fixed code vector output section 33 where a pulse waveform signal having pulses that are arranged based on a combination of pulse positions and polarities (±) shown in the fixed code (B) is outputted as a fixed code vector. Details will be described later.

The gain code (C) is inputted into the gain vector output section 34 where an adaptive codebook gain and a fixed codebook gain are derived based on the gain code (C) and outputted.

Then, the adaptive code vector from the adaptive code vector output section 32 is multiplied by the adaptive codebook gain from the gain vector output section 34 at the multiplier 35, and the fixed code vector from the fixed code vector output section 33 is multiplied by the fixed codebook gain from the gain vector output section 34 at the multiplier 36. Both multiplication results are added together at the adder 37 so as to be outputted as a drive speech source signal of the LPC synthesizing section 38. The drive speech source signal is inputted into the LPC synthesizing section 38, and also inputted into the adaptive code vector output section 32 where it is stored as a past drive speech source signal.

The LPC synthesizing section 38 reproduces the speech signal based on the drive speech source signal outputted from the adder 37 and an LPC coefficient derived from the LSP coefficient code (D) so as to obtain a reproduced speech signal. The post filter 39 performs processing such as spectral reshaping relative to the reproduced speech signal using the LPC coefficient derived from the LSP coefficient code (D), thereby to output a reproduced speech of which the speech quality has been improved.

The foregoing structure and operation described using FIG. 6 are the general structure and operation of the ACELP speech decoder as a basis of the present invention. With respect to a characterizing part of the present invention, the fixed code (algebraic code) of the excitation parameters is a fixed code that is searched out using a fixed codebook selected from a plurality of fixed codebooks in which candidate pulse positions in pulse groups are divided, and accordingly, a method of acquiring a fixed code vector differs from the conventional one.

Specifically, one of fixed codebooks is selected from a plurality of fixed codebooks like those on the speech coding side according to pitch period information from the adaptive code vector output section 32, thereby to produce a fixed code vector using the selected fixed codebook for each of subframes forming a frame.

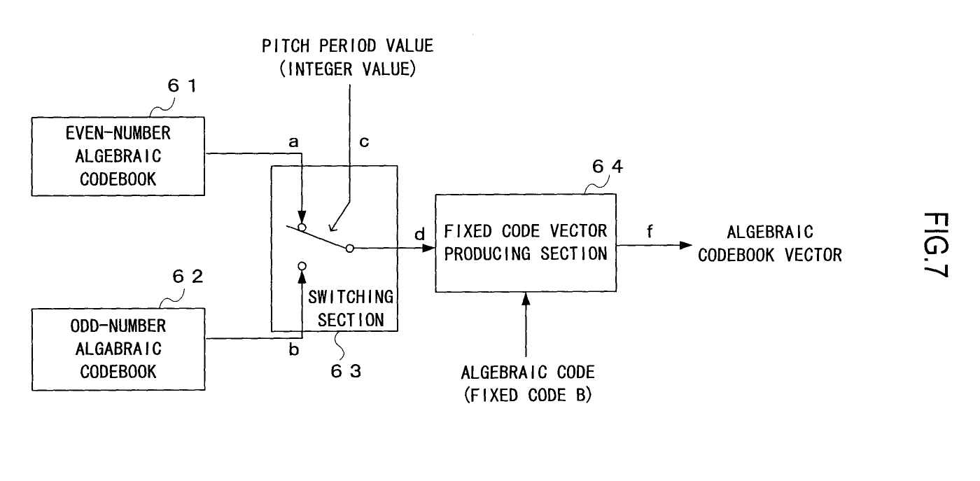

First, description will be given about an example of an internal structure of the fixed code vector output section 33 in the speech decoder of the present invention, using FIG. 7. FIG. 7 is a block diagram showing an internal structure of the fixed code vector output section 33 in the speech decoder of the present invention. FIG. 7 shows the structure corresponding to the fixed codebook search section 5 on the speech coding side described with reference to FIG. 2, wherein the candidate pulse positions are divided into two.

As shown in FIG. 7, the inside of the fixed code vector output section 33 in the speech decoder of the present invention comprises an even-number algebraic codebook 61, an odd-number algebraic codebook 62, a switching section 63, and a fixed code vector producing section 64.

Here, the even-number algebraic codebook 61 and the odd-number algebraic codebook 62 correspond to divided candidate position tables in claims and, in particular, the even-number algebraic codebook 61 corresponds to an even-number candidate position table, while the odd-number algebraic codebook 62 corresponds to an odd-number candidate position table.

The respective sections of the inside of the fixed code vector output section 33 will be described.

The even-number algebraic codebook 61 corresponds to the even-number algebraic codebook 51 on the speech coder side, and retains in a table the candidate pulse positions of even-number arrangement as shown in Table 2. The even-number algebraic codebook 61 outputs information about the retained pulse positions as even-number candidate pulse positions a according to a request.

The odd-number algebraic codebook 62 corresponds to the odd-number algebraic codebook 52 on the speech coder side, and retains in a table the candidate pulse positions of odd-number arrangement as shown in Table 3. The odd-number algebraic codebook 62 outputs information about the retained pulse positions as odd-number candidate pulse positions b according to a request.

The switching section 63 is inputted with pitch period information (pitch period value) c outputted from the adaptive code vector output section 32, and switches between the even-number candidate pulse positions a from the even-number algebraic codebook 61 and the odd-number candidate pulse positions b from the odd-number algebraic codebook 62 depending on a value of integral part of the inputted pitch period value, thereby to output them as candidate pulse position information d.

Specifically, the switching section 63 derives the integral part of the inputted pitch period value c to judge whether the integral part is an odd number or an even number. If it is the even number, the switching section 63 switches upward in the figure so that the even-number candidate pulse positions a composed of only the even numbers and obtained from the even-number algebraic codebook 61 are inputted into the fixed code vector producing section 64 as the candidate pulse position information d. On the other hand, if it is the odd number, the switching section 63 switches downward in the figure so that the odd-number candidate pulse positions b composed of only the odd numbers and obtained from the odd-number algebraic codebook 62 are inputted into the fixed code vector producing section 64 as the candidate pulse position information d.

It may also be configured that a value of integral part of the pitch period value c is derived at the adaptive code vector output section 32, and inputted into the switching section 63.

The fixed code vector producing section 64 is inputted with the fixed code (B) from the separating section 31, and produces a fixed code vector (algebraic codebook vector) having pulses that are raised in candidate pulse positions of the candidate pulse position information d inputted from the switching section 63, correspondingly to the polarities and indexes of the pulses represented by the fixed code (B) (algebraic code), and then outputs it.

Description will be given about an operation of the fixed code vector output section 33 of the present invention, using FIG. 7.

In the fixed code vector output section 33 of the present invention, the pitch period information (pitch period value) c outputted from the adaptive code vector output section 32 is inputted into the switching section 63, and a value of integral part of the pitch period information (pitch period value) is derived and, if the integral part is an even number, the even-number candidate pulse positions a from the even-number algebraic codebook 61 are inputted into the fixed code vector producing section 64 as the candidate pulse position information d, while, if the integral part is an odd number, the odd-number candidate pulse positions b from the odd-number algebraic codebook 62 are inputted into the fixed code vector producing section 64 as the candidate pulse position information d.

Then, the fixed code vector producing section 64 produces a fixed code vector (algebraic codebook vector) having pulses that are raised in candidate pulse positions of the candidate pulse position information d inputted from the switching section 63, correspondingly to the polarities and indexes of the pulses represented by the fixed code (B) from the separating section 31, and outputs it.

In the foregoing description, for agreement with the speech coding side, when the integral part of the pitch period information is an even number, the candidate pulse positions of even-number arrangement retained in the even-number algebraic codebook 61 are selected and searched, while, when the integral part is an odd number, the candidate pulse positions of odd-number arrangement retained in the odd-number algebraic codebook 62 are selected and searched. However, if the speech coding side employs inverse selection, this also applies to the speech decoding side.

In the foregoing description using the structural examples shown in FIGS. 2 and 7, the number of divided algebraic codebooks is two. However, the present invention is not limited thereto. For example, if the number of divisions is four, there are provided a first algebraic codebook composed of the first and fifth columns in the CS-ACELP candidate pulse positions shown in Table 1, a second algebraic codebook composed of the second and sixth columns therein, a third algebraic codebook composed of the third and seventh columns therein, and a fourth algebraic codebook composed of the fourth and eighth columns therein.

Then, for example, the switching section 53 executes a control of selecting the first algebraic codebook when the integral part of the pitch period information is a multiple of four, the second algebraic codebook when it is a multiple of four+1, the third algebraic codebook when it is a multiple of four+2, and the fourth algebraic codebook when it is a multiple of four+3.

Then, necessarily, for agreement with the coding side, the decoding side also retains four like algebraic codebooks, and the switching section 63 executes a control in the same manner as the switching section 53.

Even if an error occurs between the pitch period information upon coding and the decoded pitch period information due to a transmission error so that, for example, an even number/odd number is wrongly recognized, the quality degradation can still be suppressed as compared with the conventional second bit rate reducing technique that simply omits the candidate pulse positions.

According to the speech coding method and the speech coder using the ACELP system in accordance with the embodiment of the present invention, in the algebraic codebook search conducted at the fixed codebook search section 5, the candidate pulse positions within the groups in the candidate position table are divided into a plurality of portions thereby to provide a plurality of divided candidate position tables, the switching section 53 selects one divided candidate position table from the plurality of divided candidate position tables based on the pitch period value and, according to the selected divided candidate position table, the minimum distortion pulse combination searching section 54 searches for a combination of the pulse positions, one in each group, which minimizes distortion. Therefore, there is achieved an effect of, with reduction of a load of the algebraic codebook searching process and with the simple processing, suppressing degradation of the reproduced speech quality as much as possible while reducing information allocated to the algebraic codebook information, thereby improving the transmission efficiency.

According to the speech coding method and the speech coder using the ACELP system in accordance with the embodiment of the present invention, the fixed codebook search section 5 divides the candidate pulse positions within the groups in the candidate position table into two portions, i.e. odd-number positions and even-number positions, so as to provide the odd-number algebraic codebook 52 having the odd-number positions as candidates, and the even-number algebraic codebook 51 having the even-number positions as candidates, and the switching section 53 selects the odd-number algebraic codebook 52 or the even-number algebraic codebook 51 based on the value of the integral part of the pitch period value. Therefore, there is achieved an effect of, with the simple processing, suppressing degradation of the reproduced speech quality as much as possible while reducing information allocated to the algebraic codebook information, thereby improving the transmission efficiency.

According to the speech decoding method and the speech decoder corresponding to the speech coding method and the speech coder in accordance with the embodiment of the present invention, in the algebraic codebook vector production implemented at the fixed code vector output section 33 for producing the speech source signal from the coded data expressed by the combination of pulses, there are provided a plurality of divided candidate position tables like those used in the coding, the switching section 63 selects one divided candidate position table from the plurality of divided candidate position tables based on the decoded pitch period value and, according to the selected divided candidate position table, the fixed code vector producing section 64 produces the algebraic codebook vector having pulses of the pulse positions corresponding to the coded data. Therefore, there is achieved an effect of, with the simple processing, producing the reproduced speech with the quality degradation suppressed as much as possible, even from the algebraic codebook information with the reduced amount of information, thereby improving the transmission efficiency.

According to the speech decoding method and the speech decoder in accordance with the embodiment of the present invention, the fixed code vector output section 33 is provided with the odd-number algebraic codebook 62 and the even-number algebraic codebook 61 like those used in the coding, and the switching section 63 selects the odd-number algebraic codebook 62 or the even-number algebraic codebook 61 based on the value of the integral part of the decoded pitch period value. Therefore, there is achieved an effect of, with the simple processing, producing the reproduced speech with the quality degradation suppressed as much as possible, even from the algebraic codebook information with the reduced amount of information, thereby improving the transmission efficiency.

Further, additional processing required for applying the present invention to the speech coding/decoding method using the conventional CS-ACELP system is about 50 steps, which is very small in processing amount. Therefore, there is achieved an effect of, without complicating the processing, with reduction of a load of the algebraic codebook searching process and with the simple processing, suppressing degradation of the reproduced speech quality as much as possible while reducing information allocated to the algebraic codebook information.

Further, by applying the present invention, there is achieved an effect of avoiding the quality degradation that has been allowed as degradation corresponding to the bit rate reduction in the conventional second bit rate reducing technique, while ensuring the state where the bit rate reduction rate is maintained.

According to the present invention, there is provided a speech coding method comprising, in an algebraic codebook search expressing a speech source signal of an input speech signal by a combination of pulses and, according to a candidate position table in which candidate pulse positions are divided into groups so as to be determined per group beforehand, searching for a combination of the pulse positions, one in each group, which minimizes distortion, dividing the candidate pulse positions within the groups in the candidate position table into a plurality of portions so as to provide a plurality of divided candidate position tables; and selecting one divided candidate position table from the plurality of divided candidate position tables based on a pitch period value and, according to the selected divided candidate position table, searching for a combination of the pulse positions, one in each group, which minimizes the distortion. Therefore, there is achieved an effect of, with reduction of a load of the algebraic codebook searching process and with the simple processing, suppressing degradation of the reproduced speech quality as much as possible while reducing information allocated to the algebraic codebook information, thereby improving the transmission efficiency.

According to the present invention, the foregoing speech coding method divides the candidate pulse positions within the groups in the candidate position table into odd-number positions and even-number positions so as to provide an odd-number candidate position table having the odd-number positions as candidates and an even-number candidate position table having the even-number positions as candidates, and selects one of the odd-number candidate position table and the even-number candidate position table based on a value of integral part of the pitch period value. Therefore, there is achieved an effect of, with the simple processing, suppressing degradation of the reproduced speech quality as much as possible while reducing information allocated to the algebraic codebook information, thereby improving the transmission efficiency.

Further, according to the present invention, there is provided a speech decoding method comprising, in algebraic codebook vector production for producing a speech source signal from the coded data expressed by a combination of pulses, retaining a plurality of divided candidate position tables like those used in the coding; and selecting one divided candidate position table from the plurality of divided candidate position tables based on a decoded pitch period value and, according to the selected divided candidate position table, producing an algebraic codebook vector having pulses of pulse positions corresponding to the coded data. Therefore, it is possible, with the simple processing, to produce a reproduced speech with quality degradation suppressed as much as possible, even from the algebraic codebook information with reduced amount of information.

According to the present invention, there is provided a speech decoding method comprising, in algebraic codebook vector production for producing a speech source signal from the coded data expressed by a combination of pulses, retaining an odd-number candidate position table and an even-number candidate position table like those used in the coding; and selecting one of the odd-number candidate position table and the even-number candidate position table based on a value of integral part of a decoded pitch period value and, according to the selected candidate position table, producing an algebraic codebook vector having pulses of pulse positions corresponding to the coded data. Therefore, it is possible, with the simple processing, to produce a reproduced speech with quality degradation suppressed as much as possible, even from the algebraic codebook information with reduced amount of information.

Further, according to the present invention, there is provided a speech coder comprising algebraic codebook searching means for expressing a speech source signal of an input speech signal by a combination of pulses and, according to a candidate position table in which candidate pulse positions are divided into groups so as to be determined per group beforehand, searching for a combination of the pulse positions, one in each group, which minimizes distortion, wherein the algebraic codebook searching means comprises a plurality of divided candidate position tables obtained by dividing the candidate pulse positions within the groups in the candidate position table into a plurality of portions; selecting means for selecting one divided candidate position table from the plurality of divided candidate position tables based on a pitch period value; and searching means for, according to the divided candidate position table selected by the selecting means, searching for a combination of the pulse positions, one in each group, which minimizes the distortion. Therefore, there is achieved an effect of, with reduction of a load of the algebraic codebook searching process and with the simple processing, suppressing degradation of the reproduced speech quality as much as possible while reducing information allocated to the algebraic codebook information, thereby improving the transmission efficiency.

According to the present invention, the foregoing speech coder is configured that the plurality of divided candidate position tables comprise an odd-number candidate position table having as candidates odd-number positions among the candidate pulse positions of the candidate position table, and an even-number candidate position table having as candidates even-number positions thereamong, and the selecting means selects one of the odd-number candidate position table and the even-number candidate position table based on a value of integral part of the pitch period value. Therefore, there is achieved an effect of, with the simple processing, suppressing degradation of the reproduced speech quality as much as possible while reducing information allocated to the algebraic codebook information, thereby improving the transmission efficiency.

Further, according to the present invention, there is provided a speech decoder comprising algebraic codebook vector producing means for producing a speech source signal from the coded data expressed by a combination of pulses, wherein the algebraic codebook vector producing means comprises a plurality of divided candidate position tables like those used in the coding; selecting means for selecting one divided candidate position table from the plurality of divided candidate position tables based on a decoded pitch period value; and vector producing means for, according to the divided candidate position table selected by the selecting means, producing an algebraic codebook vector having pulses of pulse positions corresponding to the coded data. Therefore, there is achieved an effect of, with the simple processing, producing the reproduced speech with the quality degradation suppressed as much as possible, even from the algebraic codebook information with the reduced amount of information, thereby improving the transmission efficiency.

According to the present invention, there is provided a speech decoder comprising algebraic codebook vector producing means for producing a speech source signal from the coded data expressed by a combination of pulses, wherein the algebraic codebook vector producing means comprises an odd-number candidate position table and an even-number candidate position table like those used in the coding; selecting means for selecting one of the odd-number candidate position table and the even-number candidate position table based on a value of integral part of a decoded pitch period value; and vector producing means for, according to the candidate position table selected by the selecting means, producing an algebraic codebook vector having pulses of pulse positions corresponding to the coded data. Therefore, there is achieved an effect of, with the simple processing, producing the reproduced speech with the quality degradation suppressed as much as possible, even from the algebraic codebook information with the reduced amount of information, thereby improving the transmission efficiency.

What is claimed is:

1. A speech coding method using ACELP, comprising:
in an algebraic codebook search expressing a speech source signal of an input speech signal by a combination of pulses and, according to a candidate position table in which candidate pulse positions are divided into groups so as to be determined per group beforehand, searching for a combination of the pulse positions, one in each group, which minimizes distortion,
dividing the candidate pulse positions within the groups in said candidate position table into a plurality of portions so as to provide a plurality of divided candidate position tables; and
selecting one divided candidate position table from said plurality of divided candidate position tables based on a pitch period value and, according to the selected divided candidate position table, searching for a combination of the pulse positions, one in each group, which minimizes the distortion.

2. A speech coding method according to claim 1, comprising:
dividing the candidate pulse positions within the groups in said candidate position table into odd-number positions and even-number positions so as to provide an odd-number candidate position table having the odd-number positions as candidates and an even-number candidate position table having the even-number positions as candidates; and
selecting one of said odd-number candidate position table and said even-number candidate position table based on a value of integral part of the pitch period value.

3. A speech decoding method of decoding speech coded data coded by the speech coding method according to claim 1, said speech decoding method comprising:
in algebraic codebook vector production for producing a speech source signal from the coded data expressed by a combination of pulses,
retaining a plurality of divided candidate position tables like those used in the coding; and
selecting one divided candidate position table from said plurality of divided candidate position tables based on a decoded pitch period value and, according to the selected divided candidate position table, producing an algebraic codebook vector having pulses of pulse positions corresponding to the coded data.

4. A speech decoding method of decoding speech coded data coded by the speech coding method according to claim 2, said speech decoding method comprising:
in algebraic codebook vector production for producing a speech source signal from the coded data expressed by a combination of pulses,
retaining an odd-number candidate position table and an even-number candidate position table like those used in the coding; and
selecting one of said odd-number candidate position table and said even-number candidate position table based on a value of integral part of a decoded pitch period value and, according to the selected candidate position table, producing an algebraic codebook vector having pulses of pulse positions corresponding to the coded data.

5. A speech coder using ACELP, comprising:
algebraic codebook searching means for expressing a speech source signal of an input speech signal by a combination of pulses and, according to a candidate position table in which candidate pulse positions are divided into groups so as to be determined per group beforehand, searching for a combination of the pulse positions, one in each group, which minimizes distortion,
said algebraic codebook searching means comprising:
a plurality of divided candidate position tables obtained by dividing the candidate pulse positions within the groups in said candidate position table into a plurality of portions;
selecting means for selecting one divided candidate position table from said plurality of divided candidate position tables based on a pitch period value; and
searching means for, according to the divided candidate position table selected by said selecting means, searching for a combination of the pulse positions, one in each group, which minimizes the distortion.

6. A speech coder according to claim 5, wherein said plurality of divided candidate position tables comprise an odd-number candidate position table having as candidates odd-number positions among the candidate pulse positions of the candidate position table, and an even-number candidate position table having as candidates even-number positions thereamong, and said selecting means selects one of said odd-number candidate position table and said even-number candidate position table based on a value of integral part of the pitch period value.

7. A speech decoder for decoding speech coded data coded by the speech coder according to claim 5, said speech decoder comprising:
algebraic codebook vector producing means for producing a speech source signal from the coded data expressed by a combination of pulses, said algebraic codebook vector producing means comprising:
a plurality of divided candidate position tables like those used in the coding;
selecting means for selecting one divided candidate position table from said plurality of divided candidate position tables based on a decoded pitch period value; and
vector producing means for, according to the divided candidate position table selected by said selecting means, producing an algebraic codebook vector having pulses of pulse positions corresponding to the coded data.

8. A speech decoder for decoding speech coded data coded by the speech coder according to claim 6, said speech decoder comprising:
algebraic codebook vector producing means for producing a speech source signal from the coded data expressed by a combination of pulses, said algebraic codebook vector producing means comprising:
an odd-number candidate position table and an even-number candidate position table like those used in the coding;
selecting means for selecting one of said odd-number candidate position table and said even-number candidate position table based on a value of integral part of a decoded pitch period value; and
vector producing means for, according to the candidate position table selected by said selecting means, producing an algebraic codebook vector having pulses of pulse positions corresponding to the coded data.
